(19) United States
(12) Patent Application Publication
(10) Pub. No.: US 2022/0091433 A1
(43) Pub. Date: Mar. 24, 2022

(54) FOLDING GLASSES

(71) Applicant: Choon Kheang Ng, Tainan (TW)

(72) Inventor: Choon Kheang Ng, Tainan (TW)

(73) Assignee: TEAMWORKS GLASSES CORP, Tainan (TW)

(21) Appl. No.: 16/948,577

(22) Filed: Sep. 23, 2020

(51) Int. Cl. G02C 5/08; G02C 5/00

(52) U.S. Cl. CPC G02C 5/08; G02C 5/006

(57) ABSTRACT

A pair of folding glasses includes a frame including two fronts, a bridge pivotably located between the two fronts, and two temples pivotably connected to the two fronts. Each front includes a connection portion which has a first notch defined in the top thereof. The bridge includes two recesses which are respectively engaged with the first notch of the two connection portions. Two wings extend form the two ends of the bridge and each wing include a hole. Two positioning units pivotably position the two wings to the two connection portions. Two positioning units connect the bridge to the two connection portions. Two arms are retractably inserted into the two temples via two respective openings in one end of each temple. The two fronts are pivotable about the two positioning units. The two temples are pivotable relative to the fronts.

### BACKGROUND OF THE INVENTION

### 1. Fields of the Invention

The present invention relates to a pair of folding glasses with foldable temples.

### 2. Descriptions of Related Art

The conventional eyeglasses include two fronts and two temples. A bridge is formed between the two fronts, and a lens is installed to each front. The two temples are pivotably connected to the two fronts. The temples can be folded toward the fronts when not in use, and the folded status reduces the room required for the glasses so that the glasses can be received in a box. However, the length of the folded glasses is not shortened which is not convenient to be stored and carried.

FIG. 1 discloses a pair of folding glasses which includes two fronts “A”, and a bridge “B” is pivotably connected between the two fronts “A”. A lens “A1” is installed to each front “A”. Two screws “C” are used to pivotably connect the bridge “B” to the two fronts “A”. Two temples “D” are pivotably connected to the two fronts “A” by screws “C”. Each temple “D” includes a pivotal structure at the middle position thereof, the pivotal structure is cooperated with another screw “C”. Therefore, each temple “D” can be folded at the middle position.

The two fronts “A” can be folded by loosening the screw “C” that pivotally connect the bridge “B” to the fronts “A”. The two temples “D” can be folded relative to the fronts “A”, and each temple “D” can be further folded at the middle position thereof. The folded status of the conventional folding glasses is compact for convenient of storage and carried. However, the screws “C” are easily loosened, and the screws “C” may even drop and difficult to be found. Besides, the folded temples “D are located at the inside of the fronts “A”, and this folded status increases the thickness of the folded glasses. The lenses “A1” may be scratched by the temples “D”.

The present invention intends to provide a pair of folding glasses to eliminate shortcomings mentioned above.

### SUMMARY OF THE INVENTION

The present invention relates to a pair of folding glasses and comprises a frame including two fronts with a lens installed to each front. Each front includes a connection portion and an end piece respectively formed to two ends thereof. Each connection portion includes a first notch defined in the top thereof. A bridge is located between the two fronts and includes two recesses respectively defined in two ends of its lower edge of the bridge. The recesses of the bridge are engaged with the first notch of the two connection portions. Two wings extend form the two ends of the bridge and each wing includes a hole. Two positioning units connect the bridge to the two connection portions. Each positioning unit includes a first rivet and a second rivet. The first rivet of each positioning unit extends through hole of the wing of the bridge corresponding thereto, and is combined with the second rivet. The second rivet is then fixed to the connection portion corresponding thereto. Two temples are respectively and pivotably connected to the two end pieces.

Preferably, each positioning unit further includes a first washer and a second washer, wherein the first washer is located between the first rivet and the bridge, and the second washer is located between the second rivet and the bridge.

Preferably, each of the end pieces includes a second notch. Each temple includes a room defined axially therein which communicates with an opening through an end of the temple. An aperture is defined through the inside wall of each of the temples and communicates with the room. Two arms are respectively inserted into the two rooms of the two temples via the two respective openings of the two temples. Each arm includes a resilient plate extending from one end thereof, and the resilient plate includes a bent portion which is engaged with the second notch of the end piece corresponding thereto. Each arm includes a slot defined axially therethrough. A positioning member extends through the slot and is secured to the aperture of the temple.

The primary object of the present invention is to provide a pair of folding glasses which does not need any screw, and the folded status of the folding glasses is compact and thinner than the conventional folding glasses.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the folded status of a conventional folding glasses;

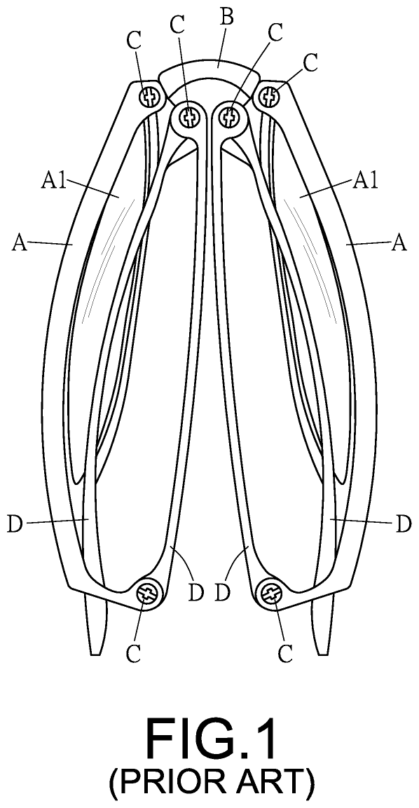

FIG. 2 is an exploded view of the folding glasses of the present invention;

FIG. 3 is a perspective view to show the folding glasses of the present invention;

FIG. 4 is a top cross sectional view, to show the connection between the fronts and the bridge of the folding glasses of the present invention;

FIG. 5 is a front view to show the connection between the fronts and the bridge of the folding glasses of the present invention;

FIG. 6 shows that the arm is extended relative to the temple of the folding glasses of the present invention;

FIG. 7 shows that the arm is inserted into the temple of the folding glasses of the present invention;

FIG. 8 shows that the temple is pivoted toward the front;

FIG. 9 is the front view of the temples being pivoted toward the fronts;

FIG. 10 is a perspective view to show that the temples are pivoted toward the fronts, and

FIG. 11 is a side view to show that the temples are pivoted toward the fronts.

### DETAILED DESCRIPTION OF THE INVENTION

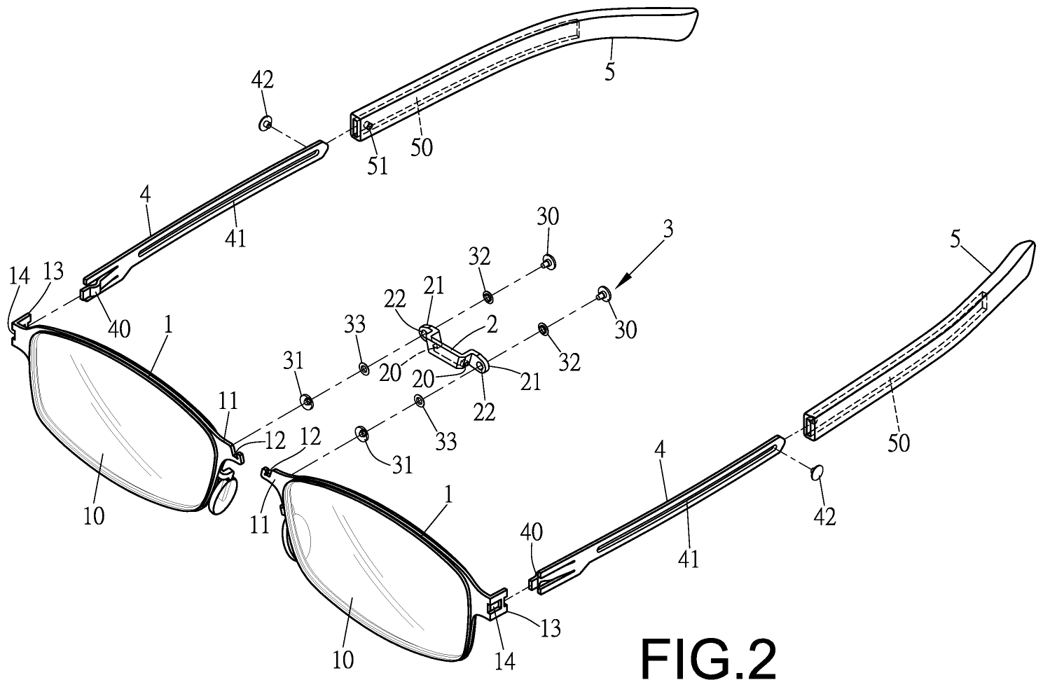

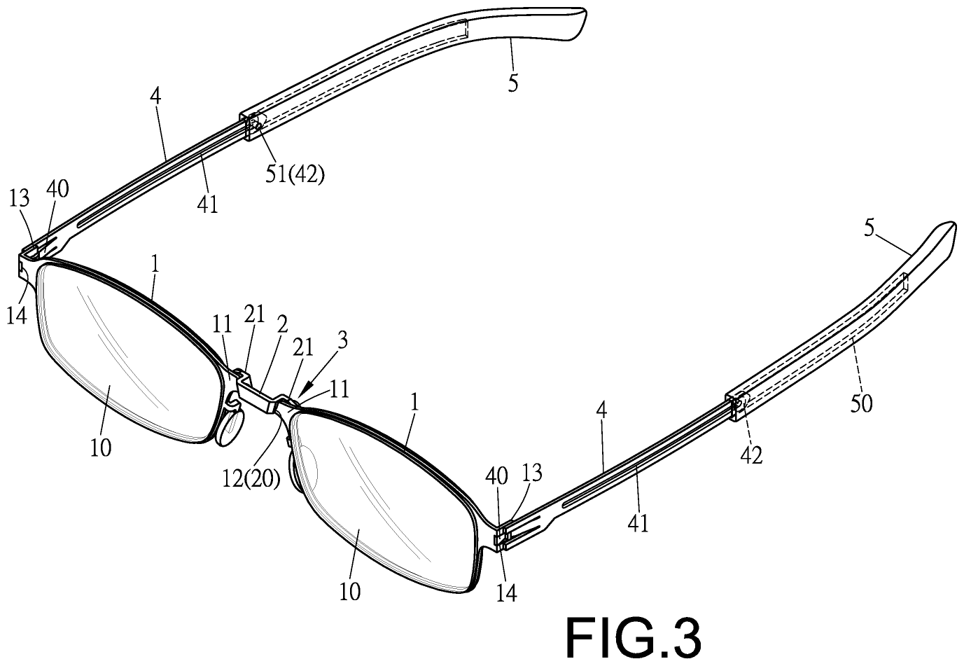

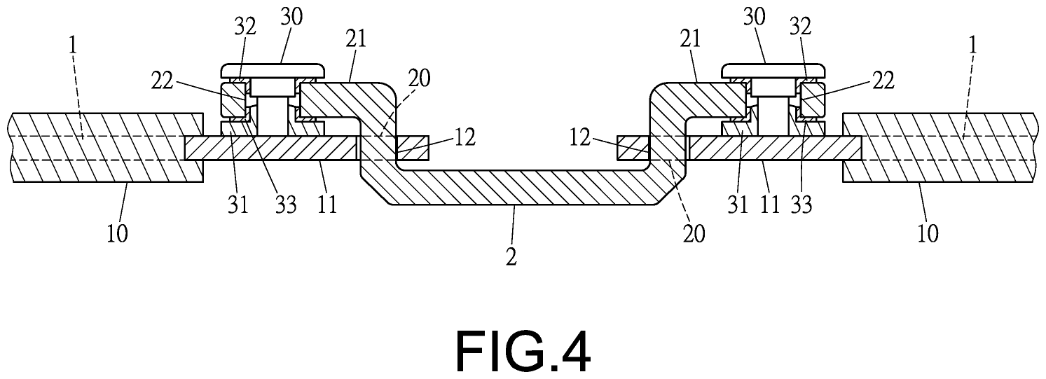

Referring to FIGS. 2 to 4, the folding glasses of the present invention comprises a frame including two fronts 1, a bridge 2 located between the two fronts 1, two positioning units 3 connecting the bridge 2 to the two connection portions 11, and two temples 5.

Each front 1 has a lens 10 connected thereto. Each front 1 includes a connection portion 11 and an end piece 13 respectively formed to two ends thereof. Each connection portion 11 includes a first notch 12 defined in the top thereof. The bridge 2 includes two recesses 20 respectively defined in two ends of the lower edge of the bridge 2. The two recesses 20 of the bridge 2 are engaged with the first notch 12 of the two connection portions 11. Two wings 21 extend form the two ends of the bridge 2, and each wing 21 includes a hole 22.

Each of the two positioning units 3 includes a first rivet 30, a second rivet 31, a first washer 32 and a second washer 33. The first washer 32 is located between the first rivet 30 and the bridge 2, the second washer 33 is located between the second rivet 31 and the bridge 2. The first rivet 30 of each positioning unit 3 extends the first washer 32, the hole 22 of the wing 21 of the bridge 2 corresponding thereto, the second washer 33, and is combined with the second rivet 31 to form a pivot. The second rivet 31 is fixed to the inner side of the connection portion 11 corresponding thereto by way of welding which can be laser welding, or ultra-sonic welding or any known method of welding.

The two temples 5 respectively and pivotably connected to the two end pieces 13. Specifically, each of the end pieces 13 includes a second notch 14. Each temple 5 includes a room 50 defined axially therein which communicates with an opening through one end of the temple 5. An aperture 51 is defined through the inside wall of each of the temples 5 and communicates with the room 50. The temples 5 each include an arm 4 which is inserted into the room 50 of the temple 5 via the opening of the temple 5. Each arm 4 includes a resilient plate 40 split from one end thereof. The resilient plate 40 includes a bent portion which is resiliently engaged with the second notch 14 of the end piece 13 corresponding thereto. Each arm 4 further includes a slot 41 defined axially therethrough. A positioning member 42 extends through the slot 41 and is secured to the aperture 51 of the temple 5. The positioning member 42 is located in the room 50.

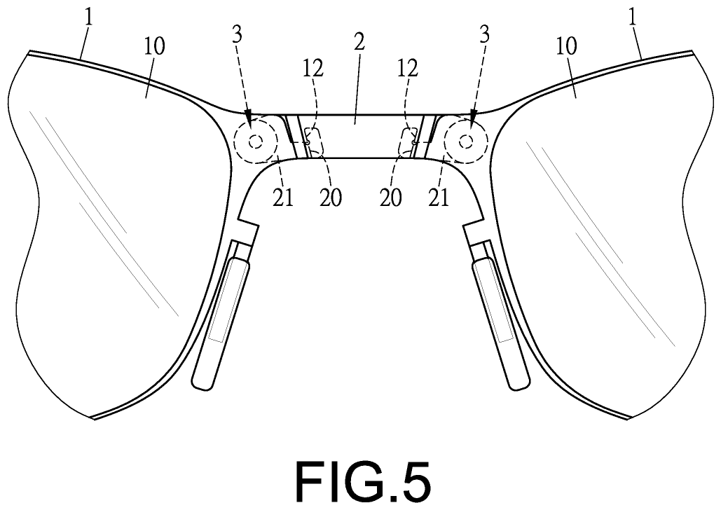

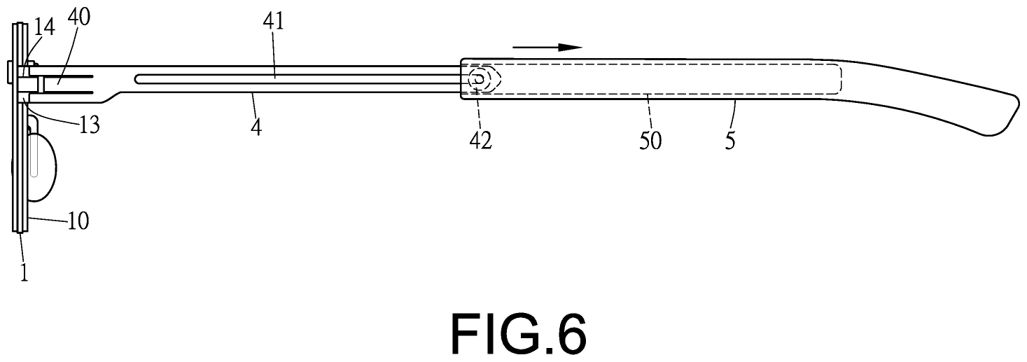

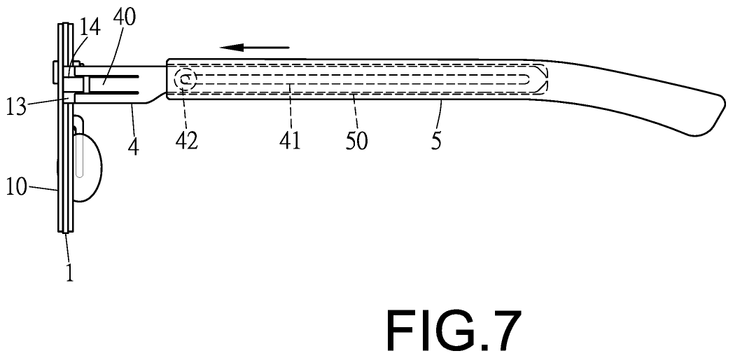

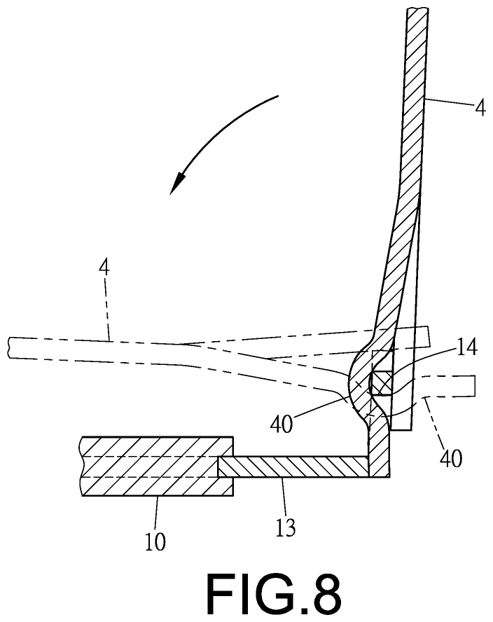

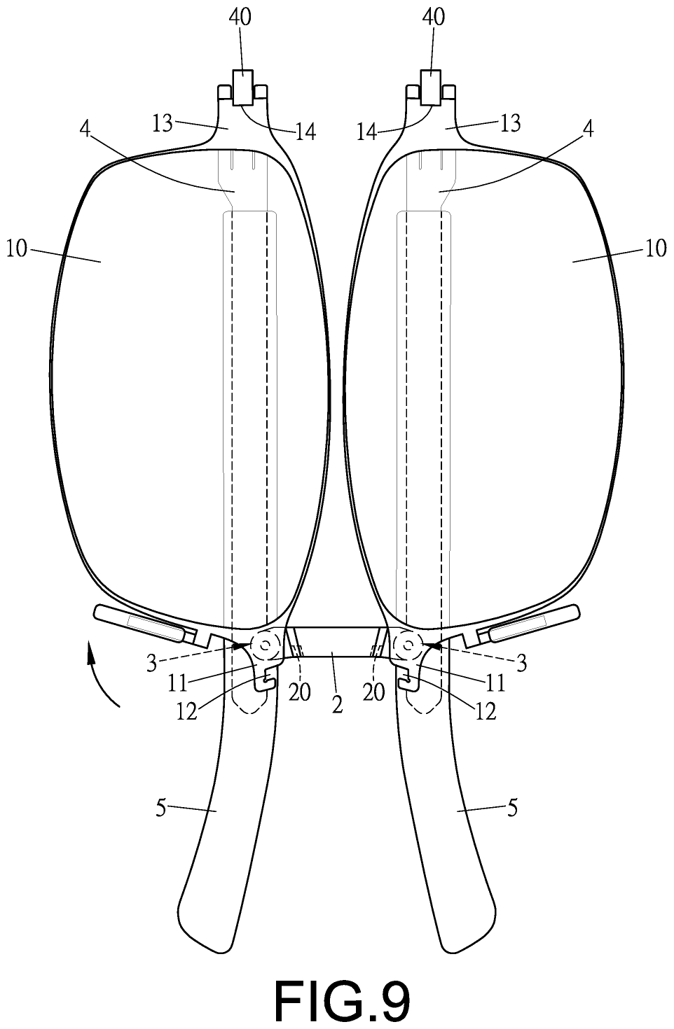

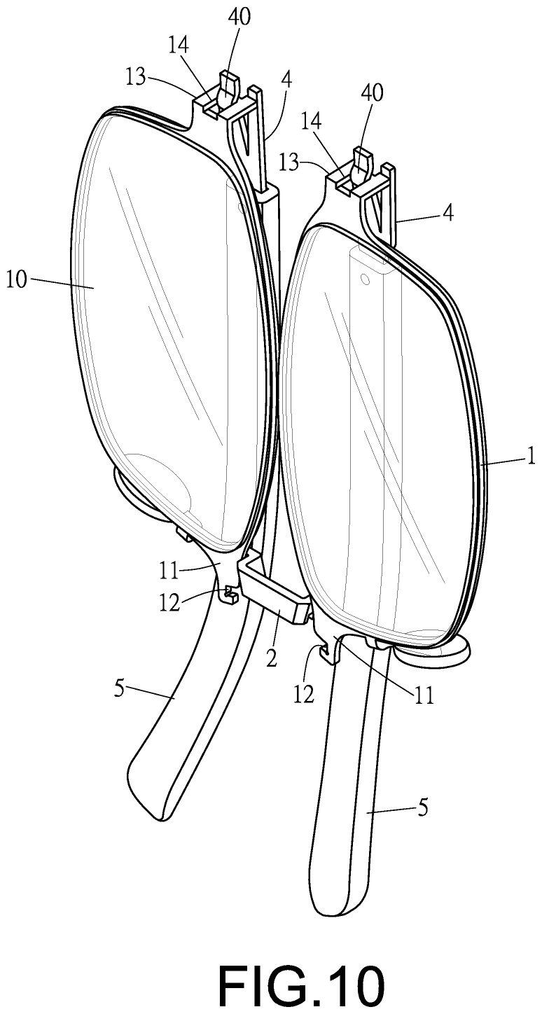

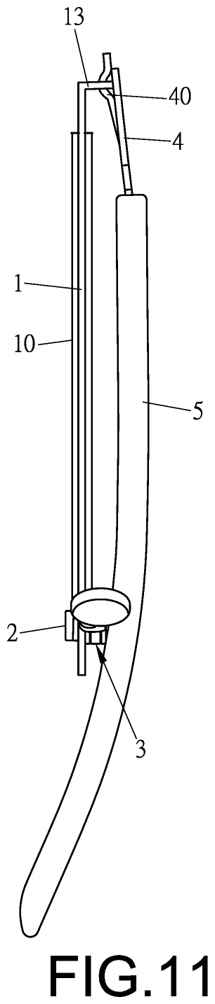

As shown in FIGS. 2 to 6, when expanding the folding glasses, pivoting the two fronts 1 downward about the positioning units 3 (the pivots) to engage the recesses 20 of the bridge 2 with the first notches 12 of the two connection portions 11 of the two fronts 1 so as to position the two fronts 1 relative to the bridge 2. The wo arms 4 are then extended relative to the temples 5 as shown in FIG. 6, the positioning members 42 slide along the slots 41 of the two arms 4. Therefore, the users can adjust the length of the combination of the arms 4 and the temples 5. When folding the glasses, as shown in FIGS. 7 to 11, pushing the temples 5 toward the fronts 1 so as to accommodate the arms 4 into the rooms 50 of the temples 5 as shown in FIG. 7. The two arms 4 with the temples 5 are pivoted about the end pieces 13 and the resilient plates 40 as shown in FIG. 8 to locate the two arms 4 with the temples 5 close to the fronts 1. The two fronts 1 are then pivoted upward about the pivots as shown in FIGS. 9, 10 and 11. The recesses 20 of the bridge 2 are removed from the first notches 12 of the two connection portions 11 of the two fronts 1. The folding glasses are folded to a compact size. It is noted that the pair of folding glasses of the present invention does not need any screw without worry of loosening. The two fronts 1 are pivoted upward so that the thickness is not increased when being folded. The lenses 10 do not contact the temples 5 and the arms 4.

While we have shown and described the embodiment in accordance with the present invention, it should be clear to those skilled in the art that further embodiments may be made without departing from the scope of the present invention.

What is claimed is:

1. A pair of folding glasses comprising:
a frame including two fronts and each front adapted to have a lens connected thereto, each front having a connection portion and an end piece respectively formed to two ends thereof, each connection portion including a first notch defined in a top thereof;
a bridge located between the two fronts, two recesses respectively defined in two ends of a lower edge of the bridge, the recesses of the bridge being engaged with the first notch of the two connection portions, two wings extending form the two ends of the bridge and each wing including a hole;
two positioning units connecting the bridge to the two connection portions, each positioning unit including a first rivet and a second rivet, the first rivet of each positioning unit extending through hole of the wing of the bridge corresponding thereto and being combined with the second rivet, and the second rivet being fixed to the connection portion corresponding thereto, and
two temples respectively and pivotably connected to the two end pieces.

2. The pair of folding glasses as claimed in claim 1, wherein each positioning unit further includes a first washer and a second washer, the first washer is located between the first rivet and the bridge, the second washer is located between the second rivet and the bridge.

3. The pair of folding glasses as claimed in claim 1, wherein each of the end pieces includes a second notch, each temple includes a room defined axially therein which communicates with an opening through an end of the temple, an aperture is defined through an inside wall of each of the temples and communicates with the room, two arms are respectively inserted into the two rooms of the two temples via the two respective openings of the two temples, each arm includes a resilient plate extending from one end thereof, the resilient plate includes a bent portion which is engaged with the second notch of the end piece corresponding thereto, each arm includes a slot defined axially therethrough, a positioning member extends through the slot and is secured to the aperture of the temple.
